(19) United States
(12) Patent Application Publication
(10) Pub. No.: US 2025/0084245 A1
(43) Pub. Date: Mar. 13, 2025

(54) Thermoplastic Resin Composition and Molded Article Manufactured Therefrom

(71) Applicant: LOTTE CHEMICAL CORPORATION, Seoul (KR)

(72) Inventors: Sang Hwa LEE, Uiwang-si (KR); Chan Moo PARK, Uiwang-si (KR); Yeong Deuk SEO, Uiwang-si (KR)

(21) Appl. No.: 18/580,305

(22) PCT Filed: Jul. 8, 2022
(86) PCT No.: PCT/KR2022/009899

§ 371 Date: Jan. 18, 2024

(30) Foreign Application Priority Data
Jul. 30, 2021 (KR) 10-2021-0100356

(51) Int. Cl. C08L 67/06; C08J 5/12; C08K 3/32; C08K 7/14

(52) U.S. Cl. CPC C08L 67/06; C08J 5/12; C08K 3/32; C08K 7/14; C08J 2367/06; C08J 2451/06; C08J 2469/00; C08K 2003/328; C08K 2201/004; C08K 2201/016; C08L 2205/03

(57) ABSTRACT

A thermoplastic resin composition of the present invention comprises: a polybutylene terephthalate resin having a titanium catalyst residual amount of less than about 50 ppm; a polycarbonate resin; a glass fiber, an epoxy-modified olefin-based polymer; and zinc phosphate. The thermoplastic resin composition has excellent metal bonding properties, thermal stability, rigidity, balance of these physical properties, and the like.

### TECHNICAL FIELD

The present invention relates to a thermoplastic resin composition and a molded article produced therefrom. More particularly, the present invention relates to a thermoplastic resin composition having good properties in terms of metal bonding, thermal stability, rigidity, balance therebetween, and the like, and a molded article produced therefrom.

### BACKGROUND ART

Nano molding technology (NMT) is a process of producing products through injection molding of a thermoplastic resin with a metal insert for specific purposes. In this field of technology, bonding strength between the metal and the thermoplastic resin is very important. In addition, a hot runner system is generally applied to such an injection process of thermoplastic materials for mass production and process efficiency. Unlike a typical cold runner system, the hot runner system requires a longer residence time of a material at a temperature above the melting point thereof. As a result, when the material does not have thermal stability, the hot runner system can cause property degradation and process problems.

To solve this problem, application of a hindered phenol stabilizer, a phosphite stabilizer or the like to polyester-based thermoplastic resin compositions has been studied. However, the problems caused by application of the hot runner system cannot be completely solved.

Therefore, there is a need for development of a thermoplastic resin composition having good properties in terms of metal bonding, thermal stability, rigidity, balance therebetween, and the like.

The background technique of the present invention is disclosed in JP Patent Registration No. 6840006 and the like.

### DISCLOSURE

### Technical Problem

It is one object of the present invention to provide a thermoplastic resin composition having good properties in terms of metal bonding, thermal stability, rigidity, balance therebetween, and the like.

It is another object of the present invention to provide a molded article formed of the thermoplastic resin composition.

The above and other objects of the present invention can be achieved by embodiments of the present invention described below.

### Technical Solution

1. One aspect of the present invention relates to a thermoplastic resin composition. The thermoplastic resin composition comprises: a polybutylene terephthalate resin having a titanium catalyst residual amount of less than about 50 ppm; a polycarbonate resin; glass fibers; an epoxy-modified olefin polymer; and zinc phosphate.
2. In embodiment 1, the thermoplastic resin composition may comprise: about 100 parts by weight of the polybutylene terephthalate resin; about 5 parts by weight to about 45 parts by weight of the polycarbonate resin; about 80 parts by weight to about 130 parts by weight of the glass fibers; about 2 parts by weight to about 25 parts by weight of the epoxy-modified olefin polymer; and about 0.1 parts by weight to about 2 parts by weight of the zinc phosphate.
3. In embodiment 1 or 2, the polycarbonate resin may have a weight average molecular weight of about 10,000 g/mol to about 50,000 g/mol.
4. In embodiments 1 to 3, the glass fibers may have a rectangular or elliptical cross-section, a cross-sectional aspect ratio (cross-sectional major diameter/cross-sectional minor diameter) of about 1.5 to about 10, and a minor diameter of about 2 um to about 10 um.
5. In embodiments 1 to 4, the epoxy-modified olefin polymer may comprise at least one of glycidyl (meth)acrylate-modified polyethylene, a glycidyl (meth)acrylate-modified ethylene-ethyl acrylate copolymer, a glycidyl (meth)acrylate-modified ethylene-butyl acrylate copolymer, and a glycidyl (meth)acrylate-modified ethylene-methyl acrylate copolymer.
6. In embodiments 1 to 5, the epoxy-modified olefin polymer and the zinc phosphate may be present in a weight ratio of about 10:1 to about 30:1.
7. In embodiments 1 to 6, the thermoplastic resin composition may have a metal bonding strength of about 35 MPa to about 50 MPa, as measured with respect to an aluminum-based metal specimen in accordance with ISO 19095.
8. In embodiments 1 to 7, the thermoplastic resin composition may have a tensile strength of about 1,500 kgf/cm² to about 1,600 kgf/cm², as measured on a 3.2 mm thick specimen in accordance with ASTM D638.
9. In embodiments 1 to 8, the thermoplastic resin composition may have a tensile strength retention rate of about 95% or more, as calculated according to Equation 1.

$$Tensile strength retention rate ( \% ) = {TS}_{1} / {TS}_{0} \times 100 \qquad [ Equation 1 ]$$

where TS₀ is an initial tensile strength of a 3.2 mm thick specimen, as measured in accordance with ASTM D638, in which the specimen is prepared through normal injection molding of pellets of the thermoplastic resin composition in an injection molding machine at a cylinder temperature of 280° C., and TS₁ is a tensile strength of a specimen, as measured in accordance with ASTM D638, in which the specimen is prepared by injection molding the pellets of the thermoplastic resin composition after the pellets are left in the injection molding machine at a cylinder temperature of 300° C. for 3 minutes.
10. In embodiments 1 to 9, the thermoplastic resin composition may have a melt-flow index increase rate of about 10% or less, as calculated according to Equation 2.

$$Melt - flow index increase rate ( \% ) = ( {MI}_{1} - {MI}_{0} ) / {MI}_{0} \times 100 \qquad [ Equation 2 ]$$

where MI₀ is a melt-flow index of pellets of the thermoplastic resin composition, as measured under a load of 5 kg in accordance with ASTM D1238 after the pellets are left at 280° C. for 5 minutes, and MI₁ is a melt-flow index of the pellets of the thermoplastic resin composition, as measured under a load of 5 kg in accordance with ASTM D1238 after the pellets are left at 280° C. for 10 minutes.
11. Another aspect of the present invention relates to a molded article. The molded article is formed of the thermoplastic resin composition according to any one of embodiments 1 to 10.
12. A further aspect of the present invention relates to a composite material. The composite material comprises: a plastic member as the molded article according to embodiment 11; and a metal member adjoining the plastic member.
13. In embodiment 12, the metal member may directly adjoin the plastic member without a bonding agent interposed therebetween.
14. In embodiment 12 or 13, the metal member may comprise at least one of aluminum, titanium, iron, and zinc.

### Advantageous Effects

The present invention provides a thermoplastic resin composition having good properties in terms of metal bonding, thermal stability, rigidity, balance therebetween, and the like, and a molded article formed therefrom.

### BEST MODE

Hereinafter, embodiments of the present invention will be described in detail.

A thermoplastic resin composition according to the present invention comprises: (A) a polybutylene terephthalate resin; (B) a polycarbonate resin; (C) glass fibers; (D) an epoxy-modified olefin polymer; and (E) zinc phosphate.

As used herein to represent a specific numerical range, “a to b” means “≥a and ≤b”.

### (A) Polybutylene Terephthalate Resin

The polybutylene terephthalate resin (PBT) according to the present invention serves to improve metal bonding, thermal stability, balance therebetween and the like of the thermoplastic resin composition together with the epoxy-modified olefin polymer and the zinc phosphate, and may have a titanium catalyst residual amount of less than about 50 ppm, for example, about 20 ppm to about 49 ppm. If the polybutylene terephthalate resin has a titanium catalyst residual amount of about 50 ppm or more, the thermoplastic resin composition can suffer from deterioration in thermal stability and the like.

In some embodiments, the polybutylene terephthalate resin may be a commercially available polybutylene terephthalate resin having a titanium catalyst residual amount of less than about 50 ppm, and the titanium catalyst residue may be measured through elemental quantitative analysis using an inductively coupled plasma-mass spectrometry (ICP-MS).

In some embodiments, the polybutylene terephthalate resin may have an intrinsic viscosity [η] of about 0.5 dL/g to about 1.5 dL/g, for example, about 0.7 dL/g to about 1.3 dL/g, as measured in accordance with ASTM D2857. Within this range, the thermoplastic resin composition can have good mechanical properties.

### (B) Polycarbonate Resin

The polycarbonate resin according to one embodiment of the present invention serves to improve impact resistance, appearance characteristics and the like of the thermoplastic resin composition and may be a polycarbonate resin used in typical thermoplastic resin compositions. For example, the polycarbonate resin may be an aromatic polycarbonate resin prepared by reacting diphenols (aromatic diol compounds) with a precursor, such as phosgene, halogen formate, carbonic diester, and the like.

In some embodiments, the diphenols may include, for example, 4,4′-biphenol, 2,2-bis(4-hydroxyphenyl)propane, 2,4-bis(4-hydroxyphenyl)-2-methylbutane, 1,1-bis(4-hydroxyphenyl)cyclohexane, 2,2-bis(3-chloro-4-hydroxyphenyl)propane, 2,2-bis(3,5-dichloro-4-hydroxyphenyl)propane, 2,2-bis(3-methyl-4-hydroxyphenyl)propane, 2,2-bis(3,5-dimethyl-4-hydroxyphenyl)propane, and the like, without being limited thereto. For example, the diphenols may be 2,2-bis-(4-hydroxyphenyl)propane, 2,2-bis(3,5-dichloro-4-hydroxyphenyl)propane, 2,2-bis(3-methyl-4-hydroxyphenyl)propane, 2,2-bis(3,5-dimethyl-4-hydroxyphenyl)propane, or 1,1-bis(4-hydroxyphenyl)cyclohexane, specifically 2,2-bis(4-hydroxyphenyl)propane, which is also referred to as bisphenol A.

In some embodiments, the polycarbonate resin may be a branched polycarbonate resin. For example, the polycarbonate resin may be a branched polycarbonate resin prepared by adding about 0.05 mol % to about 2 mol % of a tri- or higher polyfunctional compound, specifically a tri- or higher valent phenol group-containing compound, based on the total number of moles of the diphenols used in polymerization.

In some embodiments, the polycarbonate resin may be a homopolycarbonate resin, a copolycarbonate resin, or a blend thereof. The polycarbonate resin may be partially or completely replaced by an aromatic polyester-carbonate resin obtained by polymerization in the presence of an ester precursor, for example, a bifunctional carboxylic acid.

In some embodiments, the polycarbonate resin may have a weight average molecular weight (Mw) of about 10,000 g/mol to about 50,000 g/mol, for example, about 15,000 g/mol to about 30,000 g/mol, as measured by gel permeation chromatography (GPC). Within this range, the thermoplastic resin composition can have good properties in terms of impact resistance, fluidity (processability), and the like.

In some embodiments, the polycarbonate resin may be present in an amount of about 5 parts by weight to about 45 parts by weight, for example, about 15 parts by weight to about 35 parts by weight, relative to about 100 parts by weight of the polybutylene terephthalate resin. Within this range, the thermoplastic resin composition can exhibit good impact resistance, fluidity (processability), and the like.

### (C) Glass Fiber

The glass fibers according to one embodiment of the present invention serve to improve rigidity, impact resistance, metal bonding and the like of the thermoplastic resin composition, which comprises the polybutylene terephthalate resin and the polycarbonate resin, together with the epoxy-modified olefin polymer and the zinc phosphate.

In some embodiments, the glass fibers may have a rectangular or elliptical cross-section. In addition, the glass fibers may have a cross-sectional aspect ratio (cross-sectional major diameter/cross-sectional minor diameter) of about 1.5 to about 10, a minor diameter of about 2 um to about 10 μm, and a pre-processing length of about 2 mm to about 20 mm, as measured using a scanning electron microscope (SEM). Within these ranges, the thermoplastic resin composition can have improved properties in terms of rigidity, processability, and the like.

In some embodiments, the glass fibers may be treated with a typical surface treatment agent.

In some embodiments, the glass fibers may be present in an amount of about 80 parts by weight to about 130 parts by weight, for example, about 85 parts by weight to about 125 parts by weight, relative to about 100 parts by weight of the polybutylene terephthalate resin. Within this range, the thermoplastic resin composition can exhibit good properties in terms of rigidity, appearance, bending characteristics, and the like.

### (D) Epoxy-Modified Olefin Polymer

The epoxy-modified olefin polymer according to one embodiment of the present invention serves to improve metal bonding, impact resistance, rigidity, thermal stability, balance therebetween, and the like of the thermoplastic resin composition, which comprises the polybutylene terephthalate resin and the polycarbonate resin, together with the glass fibers and the zinc phosphate, and may be prepared by polymerization of an epoxy compound containing a reactive functional group with an olefin polymer (an olefin homopolymer, an olefin copolymer, an alkylene-alkyl (meth)acrylate copolymer, and the like).

In some embodiments, the epoxy compound may include glycidyl (meth)acrylate, allyl glycidyl ether, and mixtures thereof.

In some embodiments, the olefin polymer may be a homopolymer of alkylene monomers, a copolymer of alkylene monomers, and/or an alkylene-alkyl (meth)acrylate copolymer, wherein the alkylene monomers may include C₂ to C₁₀ alkylenes, for example, ethylene, propylene, isopropylene, butylene, isobutylene, octene, and the like.

In some embodiments, the epoxy-modified olefin polymer may include glycidyl (meth)acrylate-modified polyethylene, a glycidyl (meth)acrylate-modified ethylene-ethyl acrylate copolymer, a glycidyl (meth)acrylate-modified ethylene-butyl acrylate copolymer, a glycidyl (meth)acrylate-modified ethylene-methyl acrylate copolymer, and combinations thereof.

In some embodiments, the epoxy-modified olefin polymer may have a melt-flow index of about 1 g/10 min to about 50 g/10 min, for example, about 2 g/10 min to about 25 g/10 min, as measured at a temperature of 190° C. under a load of 2.16 kg in accordance with ASTM D1238. Within this range, the thermoplastic resin composition can have good properties in terms of impact resistance, metal bonding, and the like.

In some embodiments, the epoxy-modified olefin polymer may be present in an amount of about 2 parts by weight to about 25 parts by weight, for example, about 5 parts by weight to about 20 parts by weight, relative to about 100 parts by weight of the polybutylene terephthalate resin. Within this range, the thermoplastic resin composition can exhibit good properties in terms of metal bonding, thermal stability, rigidity, impact resistance, and the like.

### (E) Zinc Phosphate

The zinc phosphate according to one embodiment of the present invention serves to improve metal bonding, impact resistance, rigidity, thermal stability, balance therebetween, and the like of the thermoplastic resin composition, which comprises the polybutylene terephthalate resin and the polycarbonate resin, together with the glass fibers and the zinc phosphate, and may be typical zinc phosphate. For example, the zinc phosphate may include zinc phosphate produced through reaction of zinc oxide and phosphoric acid, commercially available zinc phosphate, and the like.

In some embodiment, the zinc phosphate may have an average particle size of about 0.5 μm to about 3 μm, for example, about 1 μm to about 3 μm, as measured by a particle analyzer, and may have a purity of about 99% or more. Within these ranges, the thermoplastic resin composition can exhibit good thermal stability, fluidity, and the like.

In some embodiments, the zinc phosphate may be present in an amount of about 0.1 parts by weight to about 2 parts by weight, for example, about 0.5 to about 1.5 parts by weight, relative to about 100 parts by weight of the polybutylene terephthalate resin. Within this range, the thermoplastic resin composition can exhibit good properties in terms of metal bonding, thermal stability, rigidity, and the like.

In some embodiments, the epoxy-modified olefin polymer (D) and the zinc phosphate (E) may be present in a weight ratio (D:E) of about 10:1 to about 30:1, for example, about 10:1 to about 30:1. Within this range, the thermoplastic resin composition can have further improved properties in terms of metal bonding, thermal stability, rigidity, impact resistance, balance therebetween, and the like.

The thermoplastic resin composition according to the present invention may further comprise additives used in typical thermoplastic resin compositions. The additives may include, for example, flame retardants, antioxidants, anti-dripping agents, lubricants, release agents, nucleating agents, antistatic agents, pigments, dyes, and mixtures thereof, without being limited thereto. In the thermoplastic resin composition, the additives may be present in an amount of about 0.001 parts by weight to about 40 parts by weight, for example, about 0.1 parts by weight to about 10 parts by weight, relative to about 100 parts by weight of the polybutylene terephthalate resin.

The thermoplastic resin composition according to one embodiment of the present invention may be prepared in pellet form by mixing the aforementioned components, followed by melt extrusion in a typical twin screw extruder at about 240° C. to about 300° C., for example, about 260° C. to about 290° C.

In some embodiments, the thermoplastic resin composition may have a metal bonding strength of about 35 MPa to about 50 MPa, for example, about 36 MPa to about 48 MPa, as measured with respect to an aluminum-based metal specimen in accordance with ISO 19095.

In some embodiments, the thermoplastic resin composition may have a tensile strength of about 1,500 kgf/cm² to about 1,600 kgf/cm², for example, about 1,530 kgf/cm² to about 1,590 kgf/cm², as measured on a 3.2 mm thick specimen in accordance with ASTM D638.

In some embodiments, the thermoplastic resin composition may have a tensile strength retention rate of about 95% or more, for example, about 96% or more, as calculated according to Equation 1.

$$Tensile strength retention rate ( \% ) = {TS}_{1} / {TS}_{0} \times 100 \qquad [ Equation 1 ]$$

where TS₀ is an initial tensile strength of a 3.2 mm thick specimen, as measured in accordance with ASTM D638, in which the specimen is prepared through normal injection molding of pellets of the thermoplastic resin composition in an injection molding machine at a cylinder temperature of 280° C., and TS₁ is a tensile strength of a specimen, as measured in accordance with ASTM D638, in which the specimen is prepared by injection molding the pellets of the thermoplastic resin composition after the pellets are left in the injection molding machine at a cylinder temperature of 300° C. for 3 minutes.

The thermoplastic resin composition may have a melt-flow index increase rate of about 10% or less, for example, about 9% or less, as calculated according to Equation 2.

$$Melt - flow index increase rate ( \% ) = ( {MI}_{1} - {MI}_{0} ) / {MI}_{0} \times 100 \qquad [ Equation 2 ]$$

where MI₀ is a melt-flow index of pellets of the thermoplastic resin composition, as measured under a load of 5 kg in accordance with ASTM D1238 after the pellets are left at 280° C. for 5 minutes, and MI₁ is a melt-flow index of the pellets of the thermoplastic resin composition, as measured under a load of 5 kg in accordance with ASTM D1238 after the pellets are left at 280° C. for 5 minutes.

A molded article according to the present invention is formed of the thermoplastic resin composition set forth above. The thermoplastic resin composition may be prepared in pellet form. The prepared pellets may be produced into various molded articles (products) by various molding methods, such as injection molding, extrusion, vacuum molding, casting, and the like. For example, the molded article according to the present invention may be produced by a molding method adopting a hot runner system for an injection molding process. These molding methods are well known to those skilled in the art to which the present invention pertains. The molded article has good properties in terms of metal bonding, thermal stability, rigidity, balance therebetween, and the like, and thus is useful as interior/exterior materials for electronic devices, interior/exterior materials for automobiles, and the like.

A composite material according to the present invention may comprise: a plastic member as the molded article; and a metal member adjoining the plastic member.

In some embodiments, the metal member may directly adjoin the plastic member without a bonding agent interposed therebetween.

In some embodiments, the metal member may comprise at least one of aluminum, titanium, iron, and zinc.

In some embodiments, the metal member may comprise aluminum and the plastic member may have a metal bonding strength of about 35 MPa to about 50 MPa, for example, about 36 MPa to about 48 MPa, as measured with respect to the metal member in accordance with ISO 19095, a tensile strength of about 1,500 kgf/cm² to about 1,600 kgf/cm², for example, about 1,530 kgf/cm² to about 1,590 kgf/cm², as measured on a 3.2 mm thick specimen in accordance with ASTM D638, a tensile strength retention rate of about 95% or more, for example, about 96% or more, as calculated according to Equation 1, and a melt-flow index increase rate of about 10% or less, for example, about 9% or less, as calculated according to Equation 2.

$$Tensile strength retention rate ( \% ) = {TS}_{1} / {TS}_{0} \times 100 \qquad [ Equation 1 ]$$

where TS₀ is an initial tensile strength of a 3.2 mm thick specimen, as measured in accordance with ASTM D638, in which the specimen is prepared through normal injection molding of pellets of the thermoplastic resin composition in an injection molding machine at a cylinder temperature of 280° C., and TS₁ is a tensile strength of a specimen, as measured in accordance with ASTM D638, in which the specimen is prepared by injection molding the pellets of the thermoplastic resin composition after the pellets are left in the injection molding machine at a cylinder temperature of 300° C. for 3 minutes.

$$Melt - flow index increase rate ( \% ) = ( {MI}_{1} - {MI}_{0} ) / {MI}_{0} \times 100 \qquad [ Equation 2 ]$$

where MI₀ is a melt-flow index of pellets of the thermoplastic resin composition, as measured under a load of 5 kg in accordance with ASTM D1238 after the pellets are left at 280° C. for 5 minutes, and MI₁ is a melt-flow index of the pellets of the thermoplastic resin composition, as measured under a load of 5 kg in accordance with ASTM D1238 after the pellets are left at 280° C. for 5 minutes.

### MODE FOR INVENTION

Next, the present invention will be described in more detail with reference to some examples. It should be understood that these examples are provided for illustration only and are not to be construed in any way as limiting the present invention.

### Example

Details of components used in Examples and Comparative Examples are as follows:
(A) Polybutylene terephthalate resin
(A1) A polybutylene terephthalate (PBT) resin (Manufacturer: Chang Chun Plastics Co., Ltd., Product name: 1100-211M, Titanium catalyst residue: about 29 ppm, Inherent viscosity [η]: about 0.9 dl/g) was used.
(A2) A polybutylene terephthalate (PBT) resin (Manufacturer: Shinkong Synthetic Fibers Corp., Product name: Shinite K006, Titanium catalyst residue: about 88 ppm, Inherent viscosity [η]: about 0.9 dl/g) was used.
(B) Polycarbonate resin
A bisphenol A polycarbonate resin (PC, manufacturer: Lotte Chemical Corporation, Weight average molecular weight: about 20,000 g/mol) was used.
(C) Glass fibers
Glass fiber (Manufacturer: Nittobo Co., Ltd., Product name: CSG 3PA-820, minor diameter: about 7 μm, Cross-sectional aspect ratio: about 4, Pre-processing length: about 3 mm) was used.
(D) Epoxy-modified olefin polymer
Glycidyl methacrylate-modified ethylene-methyl acrylate (EMA-GMA, Manufacturer: SK Functional Polymer S.A.S, Product name: AX8900) was used.
(D′) Maleic anhydride-modified polypropylene (PP-g-MAH, Manufacturer: Fine-Blend Polymer Co., Ltd., Product name: CMG9801) was used.
(E) Zinc phosphate
Zinc phosphate (Manufacturer: Budenheim, Product name: BUDIT T21) was used.
(E′) Potassium phosphate
Monopotassium phosphate (Product name: Sigma-Aldrich) was used.

### Examples 1 to 3 and Comparative Examples 1 to 3

The aforementioned components were mixed in amounts as listed in Tables 1 and 2, followed by extrusion at 260° C., thereby preparing a thermoplastic resin composition in pellet form. Here, extrusion was performed using a twin-screw extruder (L/D: 44, Φ: 45 mm). The prepared pellets were dried at 80° C. for 4 hours or more and then subjected to injection molding using a 6 oz. injection machine (molding temperature: 280° C., mold temperature: 120° C.), thereby preparing specimens. The prepared specimens were evaluated as to the following properties and results are shown in Tables 1 and 2.

### Property Evaluation

(1) Metal bonding strength (unit: MPa): Metal bonding strength was measured after bonding an aluminum-based metal specimen to a specimen of the thermoplastic resin composition by insert injection molding in accordance with ISO 19095. Here, the metal specimen was an aluminum-based metal specimen subjected to TRI surface treatment (Geo Nation Co., Ltd.) to facilitate bonding between the metal specimen and the resin specimen. Each of the metal specimen and the resin specimen had a size of 1.2 cm×4 cm×0.3 cm and bonding strength therebetween was measured after bonding the specimens to have a cross-sectional bonding area of 1.2 cm×0.3 cm.
(2) Tensile strength (unit: kgf/cm²): Tensile strength was measured on a 3.2 mm thick specimen in accordance with ASTM D638.
(3) Tensile strength retention rate (unit: %): Tensile strength retention rate was calculated according to Equation 1.

$$Tensile strength retention rate ( \% ) = {TS}_{1} / {TS}_{0} \times 100 \qquad [ Equation 1 ]$$

where TS₀ is an initial tensile strength of a 3.2 mm thick specimen, as measured in accordance with ASTM D638, in which the specimen is prepared through normal injection molding of pellets of the thermoplastic resin composition in an injection molding machine at a cylinder temperature of 280° C., and TS₁ is a tensile strength of a specimen, as measured in accordance with ASTM D638, in which the specimen is prepared by injection molding the pellets of the thermoplastic resin composition after the pellets are left in the injection molding machine at a cylinder temperature of 300° C. for 3 minutes.
(4) Melt-flow index increase rate (unit: %): Melt-flow index increase rate was calculated according to Equation 2.

$$Melt - flow index increase rate ( \% ) = ( {MI}_{1} - {MI}_{0} ) / {MI}_{0} \times 100 \qquad [ Equation 2 ]$$

where MI₀ is a melt-flow index of pellets of the thermoplastic resin composition, as measured under a load of 5 kg in accordance with ASTM D1238 after the pellets are left at 280° C. for 5 minutes, and MI₁ is a melt-flow index of the pellets of the thermoplastic resin composition, as measured under a load of 5 kg in accordance with ASTM D1238 after the pellets are left at 280° C. for 5 minutes.

TABLE 1

| | Example | | |
|---|---|---|---|
| | 1 | 2 | 3 |
| (A1) (parts by weight) | 100 | 100 | 100 |
| (A2) (parts by weight) | — | — | — |
| (B) (parts by weight) | 20 | 22 | 32 |
| (C) (parts by weight) | 115 | 89 | 122 |
| (D) (parts by weight) | 9.8 | 11 | 16 |
| (D′) (parts by weight) | — | — | — |
| (E) (parts by weight) | 0.7 | 1.1 | 1.4 |
| (E′) (parts by weight) | — | — | — |
| Metal bonding strength (MPa) | 37 | 36 | 36 |
| Tensile strength (kgf/cm²) | 1,540 | 1,580 | 1,550 |
| Tensile strength retention rate (%) | 97 | 97 | 96 |
| Melt-flow index increase rate (%) | 6 | 8 | 4 |

TABLE 2

| | Comparative Example | | |
|---|---|---|---|
| | 1 | 2 | 3 |
| (A1) (parts by weight) | — | 100 | 100 |
| (A2) (parts by weight) | 100 | — | — |
| (B) (parts by weight) | 20 | 20 | 20 |
| (C) (parts by weight) | 115 | 115 | 115 |
| (D) (parts by weight) | 9.8 | — | 9.8 |
| (D′) (parts by weight) | — | 9.8 | — |
| (E) (parts by weight) | 0.7 | 0.7 | — |
| (E′) (parts by weight) | — | — | 0.7 |
| Metal bonding strength(MPa) | 36 | 35 | 36 |
| Tensile strength (kgf/cm²) | 1,550 | 1,400 | 1,510 |
| Tensile strength retention rate (%) | 75 | 73 | 69 |
| Melt-flow index increase rate (%) | 21 | 35 | 18 |

From the results, it could be seen that the thermoplastic resin composition according to the present invention exhibited good properties in terms of metal bonding (metal bonding strength), rigidity (tensile strength), thermal stability (tensile strength retention rate, melt-flow index increase rate), balance therebetween, and the like.

Conversely, it could be seen that the resin composition of Comparative Example 1 prepared using the polybutylene terephthalate resin (A2) having a titanium catalyst residual amount of 50 ppm or more instead of the polybutylene terephthalate resin according to the present invention exhibited deterioration in thermal stability and the like; the resin composition of Comparative Example 2 prepared using the maleic anhydride-modified polypropylene (D′) instead of the epoxy-modified olefin polymer exhibited deterioration in rigidity, thermal stability, and the like; and the resin composition of Comparative Example 3 prepared using potassium phosphate (E′) instead of the zinc phosphate according to the present invention exhibited deterioration in thermal stability and the like.

Although some example embodiments have been described herein, it will be understood by those skilled in the art that various modifications, changes, and alterations can be made without departing from the spirit and scope of the invention. Therefore, it should be understood that these embodiments are provided for illustration only and are not to be construed in any way as limiting the present invention. The scope of the present invention should be defined by the appended claims rather than by the foregoing description, and the claims and equivalents thereto are intended to cover such modifications and the like as would fall within the scope of the present invention.

1. A thermoplastic resin composition comprising:
a polybutylene terephthalate resin having a titanium catalyst residual amount of less than about 50 ppm;
a polycarbonate resin;
glass fibers;
an epoxy-modified olefin polymer; and
zinc phosphate.

2. The thermoplastic resin composition according to claim 1, comprising: about 100 parts by weight of the polybutylene terephthalate resin; 5 parts by weight to about 45 parts by weight of the polycarbonate resin; about 80 parts by weight to about 130 parts by weight of the glass fibers; about 2 parts by weight to about 25 parts by weight of the epoxy-modified olefin polymer; and about 0.1 parts by weight to about 2 parts by weight of the zinc phosphate.

3. The thermoplastic resin composition according to claim 1, wherein the polycarbonate resin has a weight average molecular weight of about 10,000 g/mol to about 50,000 g/mol.

4. The thermoplastic resin composition according to claim 1, wherein the glass fibers have a rectangular or elliptical cross-section, a cross-sectional aspect ratio (cross-sectional major diameter/cross-sectional minor diameter) of about 1.5 to about 10, and a minor diameter of about 2 μm to about 10 μm.

5. The thermoplastic resin composition according to claims 1 to 4, wherein the epoxy-modified olefin polymer comprises at least one of glycidyl (meth)acrylate-modified polyethylene, a glycidyl (meth)acrylate-modified ethylene-ethyl acrylate copolymer, a glycidyl (meth)acrylate-modified ethylene-butyl acrylate copolymer, and a glycidyl (meth)acrylate-modified ethylene-methyl acrylate copolymer.

6. The thermoplastic resin composition according to claim 1, wherein the epoxy-modified olefin polymer and the zinc phosphate are present in a weight ratio of about 10:1 to about 30:1.

7. The thermoplastic resin composition according to claim 1, wherein the thermoplastic resin composition has a metal bonding strength of about 35 MPa to about 50 MPa, as measured with respect to an aluminum-based metal specimen in accordance with ISO 19095.

8. The thermoplastic resin composition according to claim 1, wherein the thermoplastic resin composition has a tensile strength of about 1,500 kgf/cm² to about 1,600 kgf/cm², as measured on a 3.2 mm thick specimen in accordance with ASTM D638.

9. The thermoplastic resin composition according to claim 1, wherein the thermoplastic resin composition has a tensile strength retention rate of about 95% or more, as calculated according to Equation 1:
$$Tensile strength retention rate ( \% ) = TS 1 / TS 0 \times 100 \qquad [ Equation 1 ]$$
where TS0 is an initial tensile strength of a 3.2 mm thick specimen, as measured in accordance with ASTM D638, in which the specimen is prepared through normal injection molding of pellets of the thermoplastic resin composition in an injection molding machine at a cylinder temperature of 280° C., and TS1 is a tensile strength of a specimen, as measured in accordance with ASTM D638, in which the specimen is prepared by injection molding the pellets of the thermoplastic resin composition after the pellets are left in the injection molding machine at a cylinder temperature of 300° C. for 3 minutes.

10. The thermoplastic resin composition according to claim 1, wherein the thermoplastic resin composition has a melt-flow index increase rate of about 10% or less, as calculated according to Equation 2:
$$Melt - flow index increase rate ( \% ) = ( MI 1 - MI 0 ) / MI 0 \times 100 \qquad [ Equation 2 ]$$
where MI0 is a melt-flow index of pellets of the thermoplastic resin composition, as measured under a load of 5 kg in accordance with ASTM D1238 after the pellets are left at 280° C. for 5 minutes, and MI1 is a melt-flow index of the pellets of the thermoplastic resin composition, as measured under a load of 5 kg in accordance with ASTM D1238 after the pellets are left at 280° C. for 5 minutes.

11. A molded article formed of the thermoplastic resin composition according to claim 1.

12. A composite material comprising:
a plastic member comprising a molded article formed of the thermoplastic resin composition according to claim 1; and
a metal member adjoining the plastic member.

13. The composite material according to claim 12, wherein the metal member directly adjoins the plastic member without a bonding agent interposed therebetween.

14. The composite material according to claim 12, wherein the metal member comprises at least one of aluminum, titanium, iron, and zinc.
